(19) United States
(12) Patent Application Publication
(10) Pub. No.: US 2025/0187045 A1
(43) Pub. Date: Jun. 12, 2025

(54) SYSTEMS AND METHODS FOR REDUCING PARTICLE CONTAMINATION IN AN ELECTRONIC DEVICE MANUFACTURING PROCESS

(71) Applicant: Skyworks Solutions, Inc., Irvine, CA (US)

(72) Inventors: Aldrin Garing Quinones, Mexicali (MX); Tomas Durante Duran, JR., Anaheim, CA (US); Mark Louie Abello Flores, Newbury Park, CA (US)

(21) Appl. No.: 18/977,888

(22) Filed: Dec. 11, 2024

Related U.S. Application Data
(60) Provisional application No. 63/609,252, filed on Dec. 12, 2023.

(51) Int. Cl. B08B 5/02

(52) U.S. Cl. CPC B08B 5/02

(57) ABSTRACT

An apparatus configured to process electronic devices during manufacture, the apparatus. The apparatus can include a mechanized member configured to actuate to move one or more electronic devices along a lane, and an air blower supported with respect to the lane such that an air flow path of the air blower intersects the lane. One or more processors can be configured to determine that a first condition has been met for activating the air blower. In response to the first condition being met, the air blower activates to blow air along the air flow path and onto the one or more electronic devices.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

The disclosure relates to methods and apparatus for processing microelectronic components during manufacture to improve yield.

### SUMMARY

In some aspects, the techniques described herein relate to an apparatus configured to process electronic devices during manufacture, the apparatus including: a mechanized member configured to actuate to move one or more electronic devices along a lane; an air blower supported with respect to the lane such that an air flow path of the air blower intersects the lane; and one or more processors configured to determine that a first condition has been met for activating the air blower, and, in response to the first condition being met, cause the air blower to activate to blow air along the air flow path and onto the one or more electronic devices as the one or more electronic devices are moved along the lane by the mechanized member.

In some aspects, the techniques described herein relate to an apparatus further including an optical detector arranged with respect to the lane such that the one or more electronic devices intersect an optical path detected by the optical detector, the one or more processors configured to determine that the first condition has been met based on one or more signals output by the optical detector.

In some aspects, the techniques described herein relate to an apparatus wherein the one or more processors are configured to determine that the first condition has been met based on the one or more signals output by the optical detector indicating that the optical path is occluded by the one or more electronic devices as they are moved through the optical path by the mechanized member.

In some aspects, the techniques described herein relate to an apparatus wherein the one or more processors are further configured, based on the one or more signals output by the optical detector, to determine that a second condition has been met for deactivating the air blower, and, in response to the second condition being met, cause the air blower to deactivate.

In some aspects, the techniques described herein relate to an apparatus wherein the one or more processors are configured to determine that the first condition has been met in response to determining that the mechanized member is moving the one or more electronic devices along the lane.

In some aspects, the techniques described herein relate to an apparatus further including a sensor arranged to detect a position of the electronic devices with respect to the air flow path, the one or more processors configured to determine that the first condition has been met in response to either 1) determining that the mechanized member is moving the one or more electronic devices along the lane, or 2) in response to one or more signals output by the sensor.

In some aspects, the techniques described herein relate to an apparatus wherein the sensor includes an optical sensor.

In some aspects, the techniques described herein relate to an apparatus wherein the air blower includes an elongate arm, a first air passage segment within and extending along the elongate arm, and an array of outlets in fluidic communication with the first air passage segment and via which air exits the air blower.

In some aspects, the techniques described herein relate to an apparatus wherein the air blower further includes at least one inlet configured to connect to an air source.

In some aspects, the techniques described herein relate to an apparatus wherein the elongate arm extends across a width of the lane.

In some aspects, the techniques described herein relate to an apparatus wherein the air blower further includes an attachment portion adapted to be mounted to the apparatus, at least a second air passage segment within the attachment portion being in fluidic communication with the first air passage segment.

In some aspects, the techniques described herein relate to an apparatus wherein the apparatus is a cleaning device.

In some aspects, the techniques described herein relate to an apparatus wherein the apparatus is a plasma cleaning device.

In some aspects, the techniques described herein relate to a method of operating an apparatus for processing electronic devices during manufacture of the electronic devices, the method including: with a mechanized member of the apparatus, moving one or more electronic devices in an automated fashion such that the one or more electronic devices pass through an air flow path of an air blower supported by the apparatus; with one or more processors, determining that a first condition has been met for activating the air blower; and in response to determining that the first condition has been met, activating the air blower to cause air to blow along the air flow path onto the one or more electronic devices.

In some aspects, the techniques described herein relate to a method wherein determining that the first condition has been met includes processing one or more signals output by an optical detector.

In some aspects, the techniques described herein relate to a method further including: with the one or more processors, processing the one or more signals output by the optical detector to determine that a second condition has been met for deactivating the air blower; and in response to determining that the second condition has been met, deactivating the air blower.

In some aspects, the techniques described herein relate to a method determining that the first condition has been met includes determining that the mechanized member is moving the one or more electronic devices.

In some aspects, the techniques described herein relate to a method wherein determining that the first condition has been met includes either 1) determining that the mechanized member is moving the one or more electronic devices, or 2) processing one or more signals output by a sensor that is arranged to detect a position of the one or more electronic devices with respect to the air flow path.

In some aspects, the techniques described herein relate to a method wherein the sensor includes an optical sensor.

In some aspects, the techniques described herein relate to a method wherein the apparatus is a cleaning device.

In some aspects, the techniques described herein relate to a method wherein the apparatus is a plasma cleaning device.

### BRIEF DESCRIPTION OF THE DRAWINGS

FIG. 1 shows an example of a station for cleaning microelectronic components that includes integrated air blowers, according to certain embodiments.

FIGS. 2A-2D shows various views of an air blower according to certain embodiments.

FIG. 3 shows a schematic view of a microelectronics cleaning station including an air blower and air blower sensor for activating the air blower, according to certain embodiments.

FIG. 4 is a flow chart depicting processing steps at a microelectronics cleaning station incorporating an integrated air blower.

FIG. 5 shows an example of blower activation logic circuitry according to certain embodiments.

FIG. 6 shows images of microelectronic components before and after using one of the integrated air blowers described herein.

### DETAILED DESCRIPTION

Contaminant reduction can improve yields in microelectronic component manufacturing. For example, electronic modules can include a module substrate having one or more semiconductor dies, surface mount devices, or other components attached thereto. If particles or other contaminants are introduced during the manufacturing process, it can cause various issues resulting in component malfunction or rejection, such as sagging or damaged wire bonds that attach the components to the substrate.

Methods and apparatus described herein reduce or remove contaminants in a microelectronic manufacturing environment using integrated air blowers to remove particles. The air blowers can be integrated with a cleaning machine (e.g., a plasma-based cleaning device), a die attach machine, or another device used in the process of manufacturing electronic components.

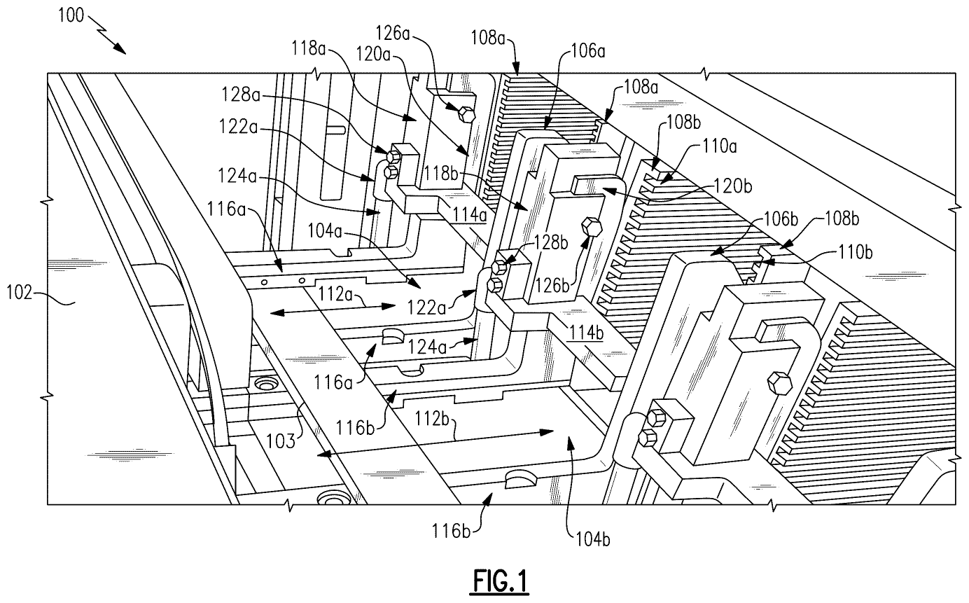

FIG. 1 shows a semiconductor cleaning system 100. The illustrated semiconductor cleaning system 100 includes a plasma-based cleaning system 102 that removes organic impurities and contaminants from semiconductor modules or other components using an energetic plasma or dielectric barrier discharge (DBD) plasma created from gaseous species. The system 102 can creating charged ions that interact with material on the surface of the components being cleaned in a cleaning chamber of the system 102.

The system 100 includes air blowers 114a, 114b that remove particles that are burnt by the plasma process and not eliminated by the plasma-based cleaning system 102. This interaction between the plasma-based cleaning system 102 and the air-blowers 114a, 114b creates a purpose that can remove dirt and other contaminants from the surface while also not altering its physical characteristics. For example, plasma cleaning can cause changes to the surface's chemical composition as well as affect how it interacts with adhesives and coatings.

The system 100 has a plurality of loading lanes 104a, 104b via which strips or trays of electronic components (not shown) travel after they leave the chamber 102 following plasma cleaning. Each loading lane 104a, 104b has a set of output magazines 106a, 106b. The output magazines 106a, 106b each have a vertical stack of opposing slots 108a, 108b. A component strip or tray can be inserted into each pair of opposing slots 108a, 108b such that the opposing slots 108a, 108b support the strip or tray therein. For instance, the topmost pair of opposing slots 110a, 110b in the stack of opposing slots 108b would hold one of the component strips or trays, with the left side of the strip or tray supported by the slot 110a and the right side of the strip or tray supported by the opposing slot 110b.

The system 100 includes a pusher 103 driven by an air cylinder piston (not shown in FIG. 1) that pushes the cleaned strips or trays out of the chamber 102, along the path 112a, 112b in each lane 104a, 104b, and into the bottom-most pair of slots of each output magazine 108a, 108b. For example, the illustrated pusher 103 comprises a board extending across the lanes 104a, 104b, which moves back and forth along the paths 112a, 112b. The pusher 103 can include a finger or prong corresponding to each lane 104a, 104b that extends from the underside of the board and that contacts the devices strips. Each loading lane 104a, 104b has a corresponding blower 114a, 114b, which is connected to a CDA (Clean Dry Air) air supply (not shown), and which blows air onto the strip or tray of electronic components as it moves along the path 112a, 112b out of the chamber 102 and towards the output magazines 108a, 108b. In this manner, the blowers 114a, 114b can remove particles from the electronic devices prior to the electronic devices entering the output magazines 108a, 108b.

Each lane 104a, 104b has a pair of elongated dividing rails 116a, 116b that delineate the lane 104a, 104b. Each blower 114a, 114b is attached to a corresponding mount portion 118a, 118b via a pair of bolts 128a, 128b. Each mount portion 118a, 118b is in turn attached via a bolt 126a, 126b to an upright portion 120a, 120b of one of the dividing members 116a, 116b.

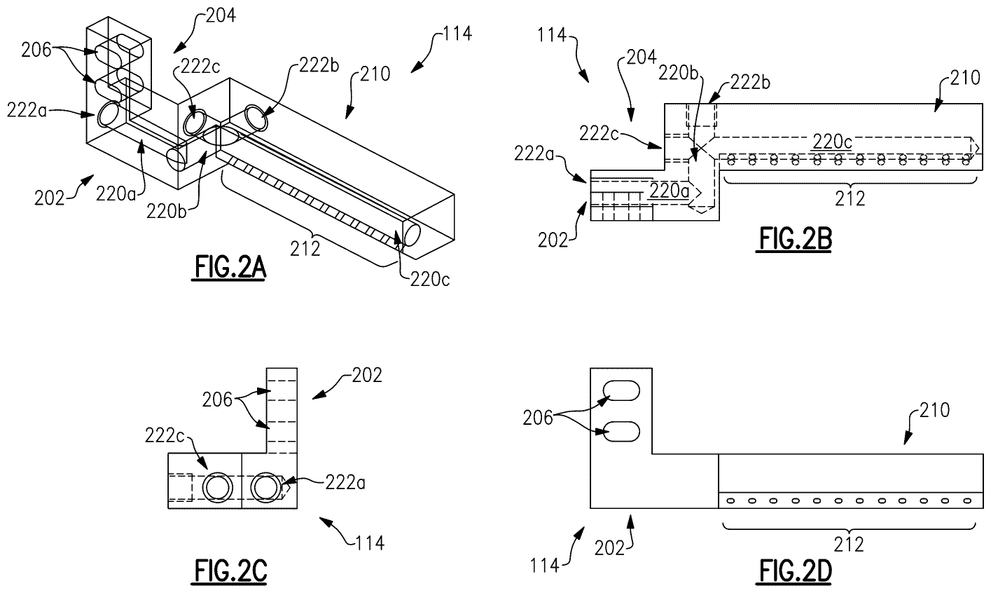

FIGS. 2A-2D show front perspective, top, left side, and front views, respectively, of a blower 114 according to certain embodiments. The blower 114 includes an attachment portion 202 that is dimensioned such that the corresponding upright portion 120 (FIG. 1) will fit within the cut-out 204 formed by the attachment portion 202. A pair of bolt holes 206 are formed through the attachment portion 202 to accommodate bolts 128 (FIG. 1) for attaching the blower 114 to the corresponding mount portion 118.

The blower 114 further includes a blower arm 210 including an array of air outlets or nozzles 212. According to various embodiments, the outlets 212 can have a pitch between the outlets of 3.5 mm, between 1 mm and 5 mm, or between 1 mm and 10 mm. According to various embodiments, the size of the outlets 212 can be about 0.5 mm, between about 0.25 mm and 0.75 mm, or between about 1 mm and 10 mm. In one embodiment, the pitch between the outlets 212 is 3.5 mm and the size of the outlets is 0.5 mm.

The blower 114 includes an internal channel including a plurality of interconnected elongate segments 220a, 220b, 220c in fluidic communication with one another. An inlet 222a provides access to the internal channel via the first segment 220a, which is connected to a second segment 220b, which is connected to a third segment 220c. While additional holes 222b, 222c are shown in FIGS. 2A-2C, the additional holes 222b, 222c are created to facilitate fabrication of the second and third segments 222b, 222c, and are permanently closed/capped after the second and third segments 222b, 222c are fabricated.

Referring to both FIGS. 1 and 2, a hose 124 connected to an air compressor or other air source can be connected to one or more of the inlets 222a, 222b, 222c via a connector fitting 122 and blow air through the channel, which is forced under pressure out of the outlets 212. For example, in FIG. 1, the hose 124a, 124b, is connected to the inlet 222a of each blower 114a, 114b and blows air into the channel, which travels through the first segment 220a, then through the second segment 220b, then through the third segment 220c, and then exits each air blower 114a, 114b via the outlets 212, allowing for pressurized air to be delivered to the electronic devices as they pass beneath the air blowers 114a, 114b in each lane 104a, 104b.

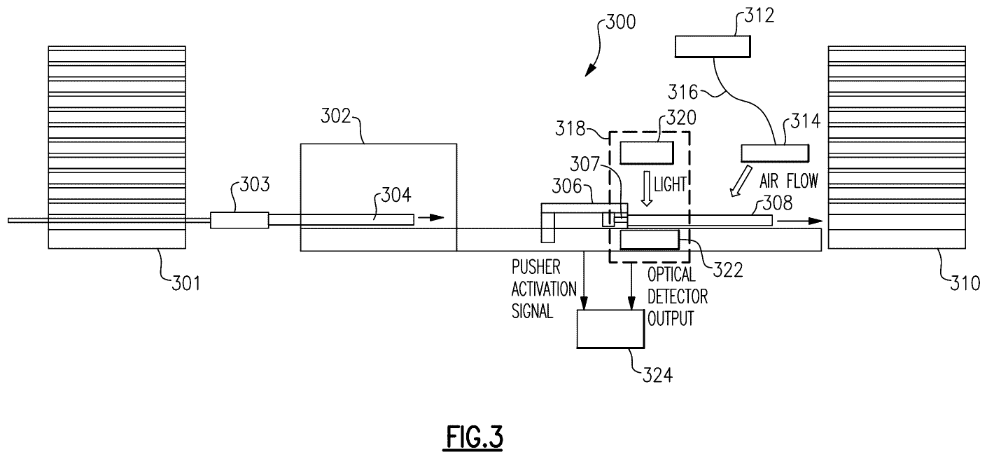

FIG. 3 shows a schematic view of a cleaning system 300 including an integrated air blower 314 and air blower sensor 318 for activating the air blower, according to certain embodiments. For example, the cleaning system 300 can be the cleaning system 100 of FIG. 1. While the system 300 may have multiple loading lanes like the system 100 of FIG. 1, FIG. 3 shows only one loading lane for illustrative purposes.

Moving from left to right in the drawing, a stack of device strips or trays holding electronic devices are serially loaded from an input magazine 301 into a cleaning chamber 302. For example, an input pusher 303 can push the bottom most device strip 304 out of the input magazine 301 and into the cleaning chamber 302. The input pusher 303 can be driven by an air cylinder piston, and the cleaning chamber 302 can have a door that the system 300 opens to allow the device strip 304 to enter the chamber 302 and that the system 300 closes after the device strip 304 is in the chamber 302. After the devices strip 304 is in the chamber 302, the input pusher 303 can retract to a position that allows it to push the next devices strip into the chamber 302. The input magazine 301 can be configured to allow for automatic feeding of the device strips. As one example, after the bottom-most device strip 304 is pushed into the cleaning chamber 302, the pusher 303 can retract and the system 300 can control the input magazine 301 to automatically move each of the loaded device strips down one level in stack of slots of the input magazine 301. Alternatively, a user can manually load a device strip 304 into the cleaning chamber 302.

After the device strip 304 (or multiple device strips where there are multiple lanes) are loaded in the chamber 302, the system 300 completes the treatment cycle (e.g., plasma cleaning).

Following treatment in the chamber 302, an output pusher 306, which is also driven by an air cylinder piston, can push the device strip 308 from the chamber 302 to a position above the blower activation logic 324 to prepare for optical system 318 to sense the presence of the device strip between the optical emitter 320 and the optical detector 322. The output pusher 306 can leave the device strip 308 in place for a user-configurable time before pushing the device strip 308 between the optical emitter 320 and the optical detector 322, and then further along The loading lane in the direction of the output magazine 310, which can hold a stack of device strips that have been processed by the cleaning system 300. The pusher 306 can include a board extending across the lanes, similar to the pusher 103 shown in FIG. 1. As shown, the pusher 306 can include a finger or prong 307 that extends from the underside of the board and that contacts the device strip 308. The finger or prong 307 can be shaped and dimensioned to establish a secure connection with the device strip.

As the device strips are pushed by the output pusher 306, the electronic components on the device strip pass under the blower 314, which is connected to an air source such as a compressor 312 via a hose 316. The blower 314 can be the blower 114 of FIG. 1 or 2 for example.

The illustrated system 300 also includes an optical system 318 for optically sensing when the device strip 308 is in position with respect to the blower 314 such that the blower 314 should be activated. The optical system 318 includes an optical emitter 320 such as an infrared LED or other light source, which emits light towards an optical detector 322. When no device strip is present in the path between the optical emitter 320 and the optical detector 322, the detector 322 detects the emitted light and can output an optical detector output signal indicating that no device strip is currently near the air flow path created by the blower 314. In contrast, when the pusher 306 pushes the device strip 308 into position such that the device strip 308 occludes the light emitted by the optical emitter 320 from reaching the optical detector 322, the optical detector 322 can output an optical detector output signal indicating that the device 308 is in a position near the air flow path of the air blower, such that the air blower 314 should be turned on.

The system 300 includes blower activation logic 324 that receives the optical detector output signal. The blower activation logic 324 can comprise circuitry, software, firmware, or a combination thereof configured to activate the blower 314 based on one or more input signals, which can include the optical detector output signal.

For example, the blower activation logic 324 can be configured to activate the blower 314 when the optical detector output signal indicates that a device strip 308 is in position (optical detector 322 not detecting light from the emitter 320) and to deactivate the blower 314 when the optical detector output signal indicates that a devices strip 308 is not in position (optical detector 322 is receiving light from the emitter 320).

The blower activation logic 324 in the illustrated embodiment also receives a pusher activation signal indicating that the pusher is currently active and pushing a device strip towards the output magazine 310. The blower activation logic 324 can use the pusher activation signal instead of or in combination with the optical detector output signal to determine when to activate the blower 314. For example, when using solely the pusher activation signal, the blower activation logic 324 can turn on the blower when the pusher activation signal indicates that the pusher 306 is currently moving and deactivate the blower 314 when the pusher activation signal indicates that the pusher is not currently moving.

The blower activation logic 324 can use both the pusher activation signal and the optical detector output signal as redundant inputs to improve the reliability of the blower 314 operation. For instance, the blower activation logic can operate according to the following:

| Blower activation | Optical detector | Blower activation |
|---|---|---|
| signal state | output signal state | logic action |
| Pusher not pushing | No light detected | Blower on |
| Pusher not pushing | Light detected | Blower off |
| Pusher pushing | No light detected | Blower on |
| Pusher pushing | Light detected | Blower on |

In this manner, the blower activation logic 324 can operate the blower 314 where one of the pusher activation signal or the optical sensor are not operating properly, or where a user is manually feeding the device strips and the pusher is therefore not active. As one example, when the pusher 306 is inactive and a user manually feeds strips into the output magazine 310, the system 300 can continue to activate and deactivate the blower 314 using the optical system 318.

The output pusher 306 eventually pushes the device strip 308 entirely into the bottom-most empty slot in the output magazine 310. At this point, the output pusher 306 can retract back towards the cleaning chamber 302 to a position in which it can grab the next devices strip from the cleaning chamber 302. The system 300 can also deactivate the blower 314. For example, once the output pusher 306 stops pushing, begins to retract, or is completely retracted, blower activation logic 324 can detect a corresponding change in the blower activation signal and deactivate the blower 314. Similarly, once the devices strip 308 and/or pusher 306 are no longer occluding the light path between the optical emitter 320 and the optical detector 322, the blower activation logic 324 can process a corresponding change in the optical detector output 322 and deactivate the blower 314. It will be appreciated that the blower activation logic can respond to blower activation signals and optical detector outputs from multiple loading lanes in parallel, although only one lane is shown in respect to FIG. 3.

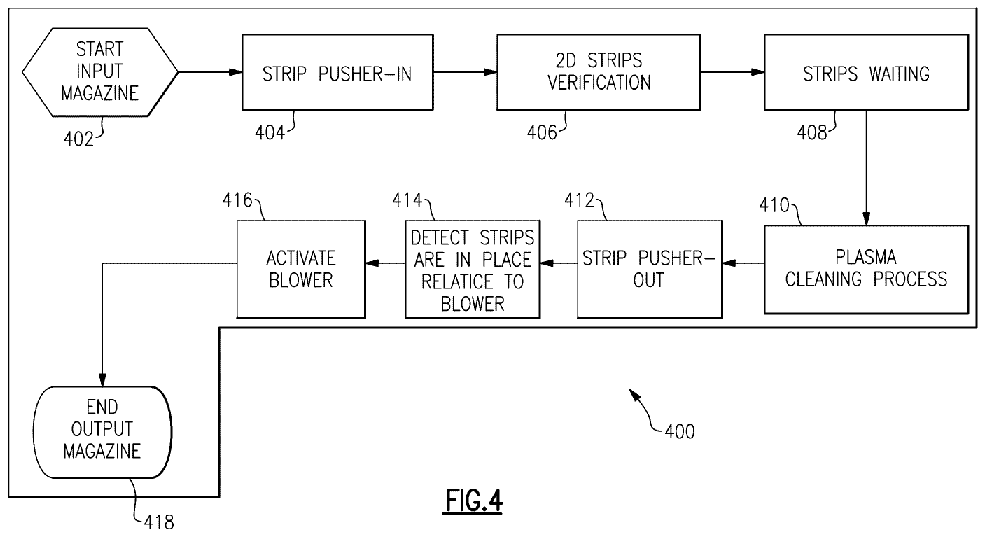

FIG. 4 is a flow chart depicting a manufacturing processing method 400 that includes the use of one or more integrated air blowers. The flow chart 400 will be described with respect to the cleaning systems 100, 300 of FIGS. 1 and 3 and the air blower 114 of FIG. 2, although other cleaning systems and air blowers can be compatible with the method 400.

At block 402, the method 400 starts by inputting device strips into an input magazine of a cleaning system, such as the input magazine 301 (FIG. 3). For example, the device strips can be manually loaded into slots in the input magazine. At block 404, the input pusher such as the input pusher 303 can push one or more device strips towards the cleaning chamber.

According to some embodiments, at block 406 the method 400 includes a strip verification stage. For example, an input pusher can push the devices strip(s) to a staging area where the system can perform a verification process on the strips to verify an identity of the device strip(s) by using a 2D barcode reader. For example, the devices strip(s) and or the integrated circuit modules or other components can include a two-dimensional alphanumeric code. The illustrated system includes a camera directed to the staging area that the system actuates to capture the 2D barcode of the devices strip(s).

The system can process ID numbers and verify the identity of the device strips for recording purposes. The system accesses a database to confirm that the strips are ready for plasma cleaning, and match each code detected using the camera with a corresponding ID in the database, and where all ID numbers match, the system can proceed to clean the device strips. On the other hand, if a match is not found, the system can issue an alert, halt operation, or discard the current device strip and load the next device strip for verification and cleaning.

Following verification, the method can include, at block 408, moving the device strips into a waiting area, until the system completes the cleaning of one or more devices strips currently undergoing cleaning in the cleaning chamber. For example, an input pusher can push the devices strips into the waiting area.

Next at block 410, the method can include moving the devise strips into the cleaning chamber and initiating the plasma cleaning.

Following the cleaning process, the method at block 412 includes pushing the plasma-cleaned devices strips out of the chamber and towards the output magazine, which can be one of the output magazines 106, 310 of FIG. 1 or FIG. 3, for example.

As the devices are moved towards the output magazine, the method at block 414 can detect that the strips are in place relative to the blower. For example, the method can implement a detection algorithm like or the same as the one implemented by the blower activation logic 324 of FIG. 3, utilizing an optical detector 318 and/or pusher activation signal, although other modes of detection are possible. At block 416, the method activates the blower(s) in response to detecting at block 414 that the devices strips are in place. The airflow from the blower(s) removes contaminants from the devices strips as the devices strips move under the blower(s) and eventually into the output magazine.

At block 418, the method ends after the device strips are pushed into the output magazine and the pusher retracts to grab another device strip. The method can also deactivate the blower(s) at this step as appropriate, e.g., in a manner described with respect to FIG. 3.

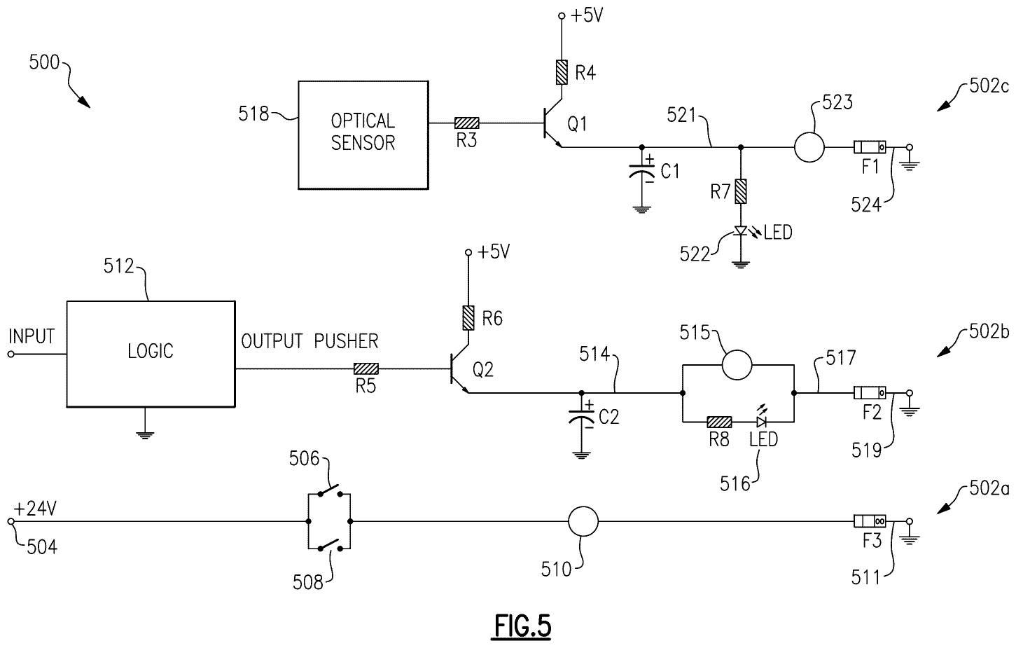

FIG. 5 shows example blower activation logic circuitry 500 according to certain embodiments. For example, the blower activation logic 324 of FIG. 3 can include such circuitry. The circuitry 500 includes a blower activation circuit 502a, a pusher detector circuit 502b, and an optical detector circuit 502c.

The blower activation circuit 500a is connected to a power source, which in the illustrated embodiment is a 24 volt power source. For example, the power source can be a 24 power source for powering a pusher of a processing system, such as the output pusher 306 of the cleaning system 300 of FIG. 3.

The blower activation circuit 502a includes a first switch 506 and a second switch 508 connected in parallel to each other and each in series between the power source 504 and a power input 510 of air compressor or other air supply. The power input 510 is connected between a fuse F3 and a node that is connected to the outputs of the switches 506, 508. The other side of the fuse is connected to the output 511, which can be connected to ground. The air compressor can be fluidly coupled to one or more integrated air blowers of a system for cleaning or otherwise processing microelectronic components. For example, the air compressor can be connected by one or more hoses to any of the air blowers described herein, such as any of the blowers 114, 314 of FIGS. 1-3, which can in turn be integrally mounted to a cleaning system, such as the systems of FIGS. 1 and 3.

For example, the power input 510 can be a solenoid of an air compressor or blower system. When both switches 506, 508 are open, the 24V power source is not connected to the power input 510, and the air compressor is not powered. On the other hand, when either of the switches 506, 508 are closed, the power source 504 is coupled to the power input 510, thereby activating the air compressor and providing compressed air to the integrated air blowers.

The pusher detector circuit 502b includes logic 512, which can be implemented in a processor or hardware circuitry. The logic 512 receives an input and outputs a pusher output signal. For example, the input could be received from a control board of a cleaner system and may the digital signal will indicates when the output pusher is active. The output of the logic 512 is the processed version of the signal received from the cleaner system and the output of the logic 512 is coupled in series with a resistor R5 to a base of a bipolar transistor Q2. The collector of the transistor Q2 is coupled in series with a resistor R6 to a power source, which is a 5V power source in the illustrated example. The emitter of the transistor Q2 is coupled to a first node 514, which is coupled in series to ground with a capacitor C2. A coil 515 is coupled between the first node 514 and a second node 517. A resistor R8 is connected in series with an LED 516 between the first node 514 and the second node 517, in parallel with the coil 515. A fuse F2 is connected between the second node 517 and an output 519, which is ground in the illustrated embodiment.

When input to the logic 512 indicates that the blower should be activated (e.g., pusher activated), the logic outputs a signal that turns on the transistor Q2, causing a current to flow from the 5V power source through the coil 515, which can be an inductive coil of a reed relay that includes the second switch 508. The capacitor C2 also charges when the transistor Q2 is on, causing a voltage potential to build at the first node 514, which turns on the LED 516. The LED 516 can be mounted to the cleaning system in a location visible to the user, thereby providing a visual indication that the blower is activated. The current flowing through the coil 515 causes the second switch 508 to close, thereby connecting the 24V power source to the solenoid or other power input 510 of the air compressor and activate the blowers. When the input to the logic 512 indicates that the blower should be deactivated, the logic 512 outputs a signal that causes the transistor Q2 to turn off. The capacitor Q2 discharges, causing the LED 516 to turn off. Current also stops flowing through the coil 515, causing the second switch 508 to open.

The optical detector circuit 502c includes an optical sensor 518. The optical sensor can include an LED coupled in series with a resistor between a 5V power source and ground. The LED is physically arranged to emit light in the direction of an optical detector. For example, the optical detector can be a phototransistor with a light sensitive base. The output of the optical detector (e.g., the emitter of the phototransistor) can be connected in series with a resistor R3 to the base of a transistor Q1. The collector of the transistor Q1 is connected to the 5V power source, and the emitter is connected to a node 521. A capacitor C1 is connected between the node 521 and ground. A resistor R7 and an LED 522 are connected in series between the node 521 and ground. A coil 523 is connected in series with a fuse F1 and an output 524, which is ground in the illustrated embodiment.

When the output of the optical sensor 518 indicates that the blower should be activated (e.g., light path occluded), the optical sensor 518 outputs a signal that turns on the transistor Q2, causing a current to flow from the 5V power source through the coil 523, which can be an inductive coil of a reed relay that includes the first switch 506. The capacitor C1 also charges when the transistor Q1 is on, causing a voltage potential to build at the node 521, which turns on the LED 522. The LED 522 can be mounted to the cleaning system in a location visible to the user, thereby providing a visual indication that the blower is activated. The current flowing through the coil 523 causes the first switch 506 to close, thereby connecting the 24V power source to the solenoid or other power input 510 of the air compressor and activate the blowers. When the output of the optical sensor 518 indicates that the blower should be deactivated, the logic 512 outputs a signal that causes the transistor Q2 to turn off. The capacitor C1 discharges, causing the LED 522 to turn off. Current also stops flowing through the coil 523, causing the first switch 506 to open.

The first and second switches 506, 508 in one embodiment are electromechanical reed switches. For example, the first switch 506 can be coupled to the coil 515 such that when current flows through the coil 515, the second switch 508 closes, and the first switch 506 can be coupled to the coil 523 such that when current flows through the coil 523, the first switch 506 closes.

In some embodiments, the first and second switches 506, 508 each form a part of an 8 pin reed relay integrated circuit.

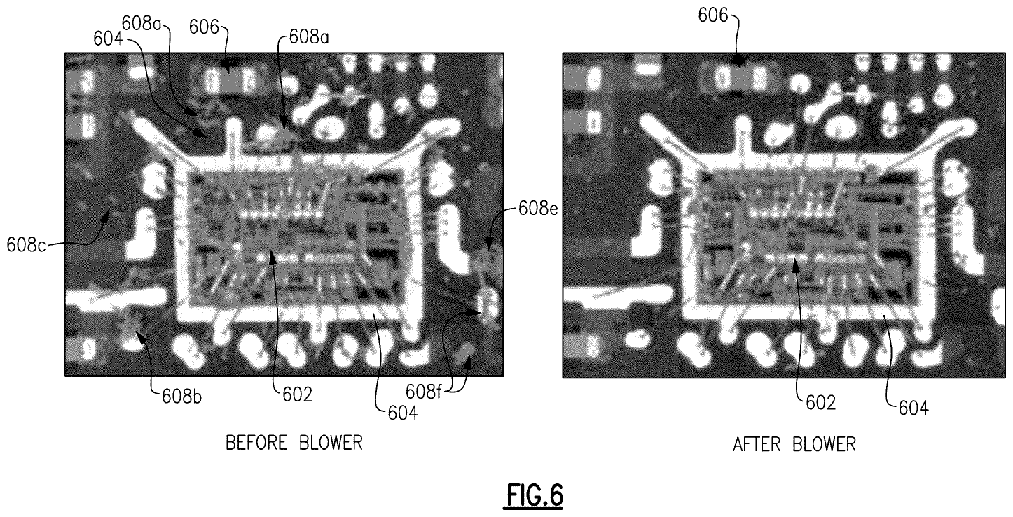

FIG. 6 shows a portion of a microelectronic component 600 that has had contaminants removed using an integrated air blower according to embodiments described herein. The microelectronic component 600 includes an integrated circuit 602 that is wire-bonded via a plurality of bond wires to a substrate 604, which can be a printed circuit board, such as a module board of a multi-chip module (MCM). The microelectronic component 600 also includes a plurality of surface mount devices (SMDs) 606, which can be resistors or other devices. The image on the left shows the component 600 before undergoing contaminant removal using an integrated air blower, and the image on the right shows the component 600 after undergoing contaminant removal. As shown, the air blower process removes numerous particles 608, which are present in the image on the left (before blowing) and not present in the image on the right (after blowing). Only a subset 608a-608f of the removed particles are specifically pointed out in FIG. 6.

While certain embodiments have been described, these embodiments have been presented by way of example only and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure.

Features, materials, characteristics, or groups described in conjunction with a particular aspect, embodiment, or example are to be understood to be applicable to any other aspect, embodiment or example described in this section or elsewhere in this specification unless incompatible therewith. All the features disclosed in this specification (including any accompanying claims, abstract and drawings), and/or all the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable sub combination. Moreover, although features may be described above as acting in certain combinations, one or more features from a claimed combination can, in some cases, be excised from the combination, and the combination may be claimed as a sub combination or variation of a sub combination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products. For example, any of the components for the systems described herein can be provided separately, or integrated together (e.g., packaged together, or attached together) to form a system.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount, depending on the desired function or desired result.

The scope of the present disclosure is not intended to be limited by the specific disclosures of preferred embodiments in this section or elsewhere in this specification and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

The headings provided herein, if any, are for convenience only and do not necessarily affect the scope or meaning of the devices and methods disclosed herein.

What is claimed is:

1. An apparatus configured to process electronic devices during manufacture, the apparatus comprising:
a mechanized member configured to actuate to move one or more electronic devices along a lane;
an air blower supported with respect to the lane such that an air flow path of the air blower intersects the lane; and
one or more processors configured to determine that a first condition has been met for activating the air blower, and, in response to the first condition being met, cause the air blower to activate to blow air along the air flow path and onto the one or more electronic devices as the one or more electronic devices are moved along the lane by the mechanized member.

2. The apparatus of claim 1 further comprising an optical detector arranged with respect to the lane such that the one or more electronic devices intersect an optical path detected by the optical detector, the one or more processors configured to determine that the first condition has been met based on one or more signals output by the optical detector.

3. The apparatus of claim 2 wherein the one or more processors are configured to determine that the first condition has been met based on the one or more signals output by the optical detector indicating that the optical path is occluded by the one or more electronic devices as they are moved through the optical path by the mechanized member.

4. The apparatus of claim 2 wherein the one or more processors are further configured, based on the one or more signals output by the optical detector, to determine that a second condition has been met for deactivating the air blower, and, in response to the second condition being met, cause the air blower to deactivate.

5. The apparatus of claim 1 wherein the one or more processors are configured to determine that the first condition has been met in response to determining that the mechanized member is moving the one or more electronic devices along the lane.

6. The apparatus of claim 1 further comprising a sensor arranged to detect a position of the electronic devices with respect to the air flow path, the one or more processors configured to determine that the first condition has been met in response to either 1) determining that the mechanized member is moving the one or more electronic devices along the lane, or 2) in response to one or more signals output by the sensor.

7. The apparatus of claim 6 wherein the sensor includes an optical sensor.

8. The apparatus of claim 1 wherein the air blower includes an elongate arm, a first air passage segment within and extending along the elongate arm, and an array of outlets in fluidic communication with the first air passage segment and via which air exits the air blower.

9. The apparatus of claim 8 wherein the air blower further includes at least one inlet configured to connect to an air source.

10. The apparatus of claim 9 wherein the elongate arm extends across a width of the lane.

11. The apparatus of claim 9 wherein the air blower further includes an attachment portion adapted to be mounted to the apparatus, at least a second air passage segment within the attachment portion being in fluidic communication with the first air passage segment.

12. The apparatus of claim 11 wherein the apparatus is a plasma cleaning device.

13. The apparatus of claim 1 wherein the mechanized member is driven by an air cylinder.

14. A method of operating an apparatus for processing electronic devices during manufacture of the electronic devices, the method comprising:
with a mechanized member of the apparatus, moving one or more electronic devices in an automated fashion such that the one or more electronic devices pass through an air flow path of an air blower supported by the apparatus;
with one or more processors, determining that a first condition has been met for activating the air blower; and
in response to determining that the first condition has been met, activating the air blower to cause air to blow along the air flow path onto the one or more electronic devices.

15. The method of claim 14 wherein determining that the first condition has been met includes processing one or more signals output by an optical detector.

16. The method of claim 15 further comprising:
with the one or more processors, processing the one or more signals output by the optical detector to determine that a second condition has been met for deactivating the air blower; and
in response to determining that the second condition has been met, deactivating the air blower.

17. The method of claim 16 determining that the first condition has been met includes determining that the mechanized member is moving the one or more electronic devices.

18. The method of claim 16 wherein determining that the first condition has been met includes either 1) determining that the mechanized member is moving the one or more electronic devices, or 2) processing one or more signals output by a sensor that is arranged to detect a position of the one or more electronic devices with respect to the air flow path.

19. The method of claim 18 wherein the sensor includes an optical sensor.

20. The method of claim 19 wherein the apparatus is a plasma cleaning device.
